(19) United States
(12) Patent Application Publication
(10) Pub. No.: US 2005/0105399 A1
(43) Pub. Date: May 19, 2005

(54) Appliance having a clock set to universal time

(76) Inventors: David Michael Strumpf, Columbia, MO (US); Derrick Edward Cochran, Columbia, MO (US); Thomas Martin Vaughn, Kent, WA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/474,562

(22) PCT Filed: Apr. 13, 2001
(86) PCT No.: PCT/US01/12223

(51) Int. Cl. G04C 11/02

(52) U.S. Cl. 368/47

(57) ABSTRACT

A appliance (100) having a receiver (324) capable of receiving and a decoder (314) capable of decoding a time signal (400) into a time value. A clock (308) in the appliance (100) is updated or set with the received time value and an indicator (104) is activated to notify consumers that time synchronization to a time signal has occurred. The decoder (314) from the decoded time signal (400) is able to identify leap years and changes to and from daylight savings time.

### BACKGROUND OF THE INVENTION

1. Technical Field

This invention relates generally to clocks and more particularly to an appliance having a clock set to Coordinated Universal Time (UTC).

2. Related Art

Consumers often have numerous appliances that have clocks for displaying time. In order to synchronize the time between the clocks in different appliances, the consumer is required to set each clock individual. Furthermore, when power outages or time changes occur, a consumer again has to reset the clocks. A common method for an appliance having a clock to maintain time during a power outage requires a second power source to be present in the appliance. But, the clock still must be initially set by the consumer and adjusted for time changes from or to “Daylight Saving Time.” Further, it is not uncommon for clocks to contain calendars for displaying date information that must be adjusted for leap years. Since the accuracy of a clock is often directly proportional to the cost, the clocks found in appliances will have time drift resulting in larger and larger inaccuracies over an increasing period of time.

Therefore, there is a need to provide an approach for maintaining and adjusting the time of stand alone clocks and clocks that are integrated with appliances while using common quality parts to correct time drift, changes from/to “Daylight Saving Time”, and leap years.

### SUMMARY

Broadly conceptualized, a clock integrated with an appliance or standing alone is connected to a receiver that receives a timing signal that can be locked on to and decoded with minimal decoding of the timing signal. A human perceptible indicator is activated upon the synchronization with the time signal and the human perceptible indicator stays on for a predetermined period after synchronization. Furthermore, a predictive process can be used to compensate for noise contained in the received timing signal. The initial time is set in the factory and automatically adjusts to time changes, thus limiting the consumer interaction to selecting the time zone for the displayed time.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is an illustration of a coffee maker appliance having an integrated clock in accordance with and embodiment of the invention;

FIG. 2 is an illustration of the coffee maker appliance of FIG. 1 connected during the manufacturing process to a server that initially supplies time to the coffee maker appliance in accordance with an embodiment of the invention;

FIG. 3 is a block diagram of the coffee maker appliance of FIG. 1 in accordance with an embodiment of the invention;

FIG. 4 is an illustration of a time signal packet received by the receiver of FIG. 3 in accordance with an embodiment of the invention;

FIG. 5 is a flow chart illustration of a process of initially setting the time in the coffee maker appliance as depicted in FIG. 2; and

FIG. 6 is a flow chart illustration of a process of setting time from the received time signal in a coffee maker appliance of FIG. 3.

### DETAILED DESCRIPTION

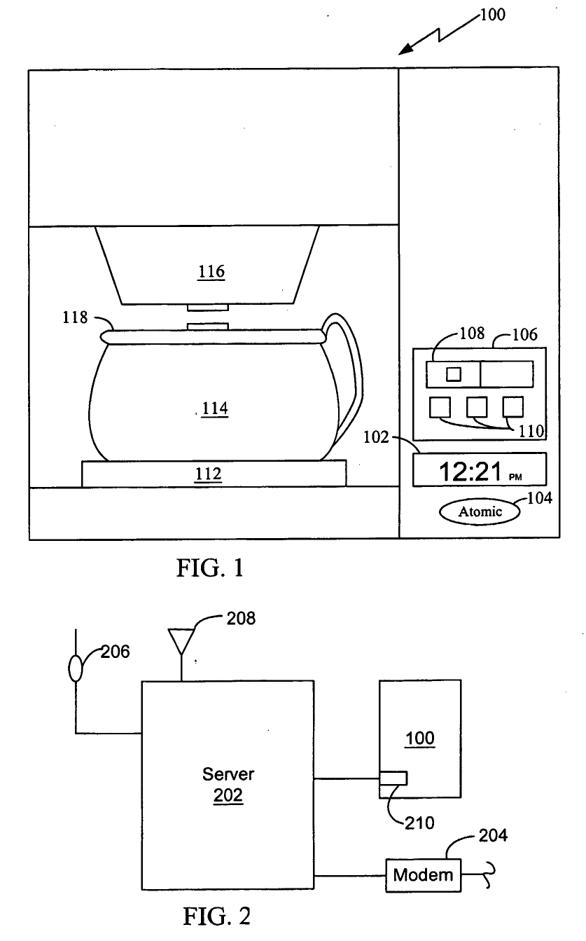

In FIG. 1, an illustration of a coffee maker appliance 100 having an integrated clock 102 is shown. The coffee maker has an indicator 104 that lights when the integrated clock 102 is synchronized with an external time signal. The input controls 106 include an on/off/auto switch 108 that turns “on” and “off” the coffee maker appliance 100 and a plurality of buttons 110 for setting the clock and auto-timer. The coffee maker appliance 100 has a hot plate 112 that supports a coffee pot 114. Water is heated in the coffee maker appliance 100 by an electric heating element (not shown). The hot water boils into the filter region 116 and drips through the coffee pot lid 118 into the coffee pot 114.

In the current embodiment, the integrated clock 102 also functions as a timer that is set using the plurality of buttons 110. The integrated clock 102 is settable using the plurality of buttons 110 when the clock is in a free running mode of operation. If the indicator 104 is lit, then the clock is in a synchronized mode and is assuring clock accuracy by receipt of a timing signal. In an alternate embodiment, the clock may be in an appliance other than a coffee maker appliance 100, for example, an oven, a stove, a refrigerator, a mixer, a bread machine, a stand-alone clock, a video recorder, a television, etc . . . . Furthermore, the integrated clock or stand-alone clock in other embodiments may be changeable even if the clock is synchronized with the timing signal by recording the amount of offset relative to the synchronized time (for example, a person setting his clock five minutes fast in order not to be late).

Turning to FIG. 2, an illustration of the coffee maker appliance 100 of FIG. 1 connected during manufacturing to a server 202 that initially sets the time in the coffee maker appliance 100. The server 202 is an electrical device, for example a personal computer, global positioning satellite signal processing device, microprocessor/micro-controller controlled device, and a device made from discrete components, that can receive and process the time signal. In the current embodiment, the server 202 is an industrial computer (such as a HP server, an IBM server, or DELL server) running without a monitor or a keyboard.

The server 202 is connected to a modem 204 that allows the server 202 to receive the timing signal by dialing into another computer in communication with the Cesium atomic clock provided by the National Institute of Standards and Technology at telephone number 303-494-4774, or via an internet connection to a stratum-1 time server provided by the National Institute of Standards and Technology (e.g. time.gov, IP Address 132.163.4.203). Additional information about the National Institute of Standards and Technology may be located on their web site (boulder.nist.gov). A clock located in the server 202 is synchronized with the Cesium atomic clock and is accessed to set the time in the coffee maker appliance 100. The time received from the Cesium atomic clock is commonly called zero or Greenwich meridian time. In an alternative embodiment, the server 202 does not have a clock and the time received from the Cesium atomic clock is used directly to set the time in the coffee maker appliance 100.

The sever 202 is also shown connected to a global positioning system (GPS) receiver 206 that provides accurate time while eliminating the inherit problems associated with wired networks. The GPS signal is received and a time signal extracted and decoded. The clock in the server 202 is synchronized with the GPS time signal and accessed to set the time in the coffee maker appliance 100.

The server 202 is shown with a third way to receive the timing signal. An antenna 108 is connected to a receiver (not shown) in the server 202. The antenna 208 enables the server 202 to receive the time signal transmitted by WWVB. WWVB is a radio station operated by the National Institute of Standards and Technology that transmits a time signal at 60 kHz. The clock contained in the server 202 is synchronized to the received WWVB time signal and accessed to set the time in the coffee maker appliance 100.

FIG. 2 demonstrates that one or more methods of receiving a timing signal may be used at the server 202 to enable the server 202 to provide accurate time to the coffee maker appliance 100. The accurate time in server 202 is used to initially set the time the coffee maker appliance 100 via a port 210 located on the coffee maker appliance 100. The port 210 may be an external port, such as a serial port, or in other embodiments contact pads on a circuit board that is accessible only during manufacturing.

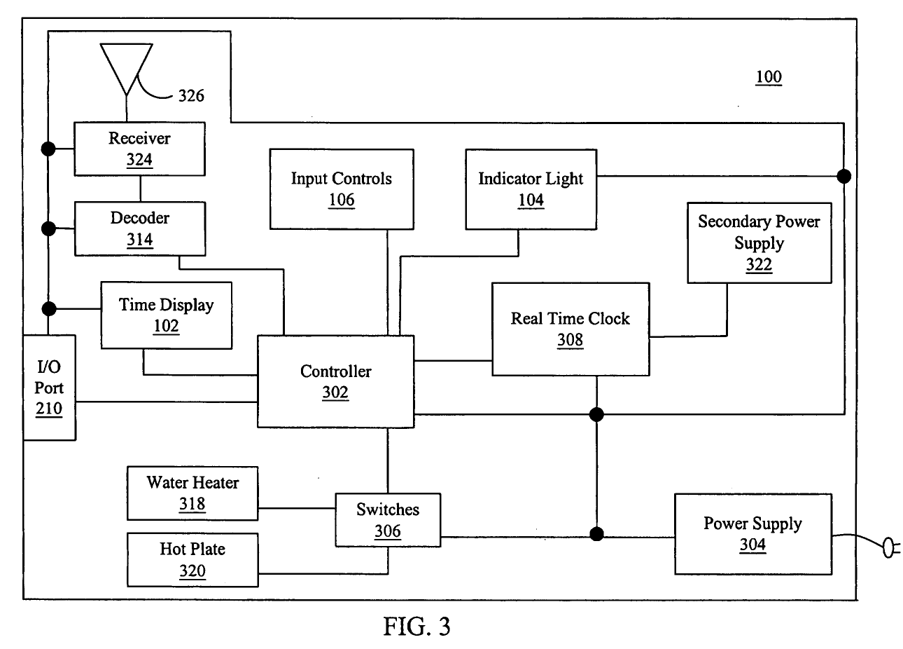

In FIG. 3, a block diagram of the coffee maker appliance 100 of FIG. 1 is shown. The coffee maker appliance 100 has a controller 302 electrically connected to a power supply 304, a plurality of input controls 106, a time display 102, an indicator light 104, an input/output (I/O) port 210, a plurality of switches 306, a real time clock 308, and a decoder 314. The plurality of switches 306 are electrically connected to the water heater 318, a hot plate 320, the controller 302, and the power supply 304. The real time clock 308 is electrically connected to the controller 302 and a secondary power supply 322. The time display 102 is electrically connected to the controller 302 and the power supply 304. The indicator light 104 is electrically connected to the controller 302 and the power supply 304. The decoder 314 is electrically connected to the power supply 304, the controller 302 and receiver 324. The receiver 304 is electrically connected to an antenna 326, the decoder 314 and the power supply 304. The power supply 304 is also connected to an electric cord 326.

The controller 302 is initially loaded with the Coordinated Universal Time (UTC) from the server FIG. 2, 202 that is connected at I/O port 210 of the coffee maker appliance 100, FIG. 3. The controller 302 updates the real time clock 308 by using the current UTC received at I/O port 210. The controller 302 also adjusts the real time clock 308 for the proper time zone as set by the consumer using a subset of the input controls 106. UTC is the time at a fixed location meridian that passes through Greenwich, England and an adjustment forward or backwards is made to that time. For example, 8:00 pm UTC would be five hours ahead of the eastern United States (8 pm−5 hrs.=3 pm). Once the UTC is set in the coffee maker apparatus, power via the cord 326 is removed. In an alternate embodiment, the time zone is set in the factory and cannot be changed.

The real time clock is kept active by a secondary power supply 322 when the main power supply 304 is unavailable. The secondary power supply 322 is a 3-volt Lithium battery, but in alternate embodiments other types of batteries or storage devices such as capacitors may selectively be used to keep the real time clock running. In the current embodiment, the real time clock is a Philips' PCF8583; Clock/calendar chip with 240×8-bit RAM. In alternate embodiments, other real time clock chips may be used in place of the PCF8583 chip. Furthermore, the controller 302 in the current embodiment is a PICmicro PIC16F876 Micro-controller. In an alternate embodiment, a different micro-controller, microprocessor, or discrete components acting as a controller may selectively be used in place of the PIC16F876 micro-controller.

The time display 102 is a multi-segment light emitting diode (LED) module manufactured by Lumex, model LDC-M5004R for displaying the current time and is coupled to the controller 302. In an alternate embodiment other types of time displays may selectively be used, including liquid crystal displays, cathode ray tubes, individual LEDs, and plasma displays. Although not shown, additional LEDs or light indicators may selectively be used to indicate if the coffee maker appliance is “on”, brewing time is set (“Auto”), and a selected time zone.

The controller 302 receives command signals from the input control 106 on/off/auto switch 108, Auto time set button, button for hour, and button for minute. The on/off/auto switch 108 in the “on” position activates the coffee maker appliance 100 and brews coffee immediately. The controller 302 receives the on signal from the on/off/auto switch 108 (which is part of the input controls 106) and activates the switches 306 to energize the water heater 318 and hot plate 320. When the controller 302 receives an “off” signal from the input control 106 on/off/auto switch 108 being in the off position, the controller 302 deactivates the switches 306 resulting in the water heater 318 and hot plate 320 being turned off.

When the controller 302 receives an “auto” signal from the input control 106 on/off/auto switch 108 being in the auto position, the controller 302 looks to the memory contained in the controller 302. The memory contains the on time value that identifies when the coffee maker appliance 100 will be turned on. The on time is set by the plurality of buttons 110 that enables an hour and minute to be entered. The controller compares the real time clock 308 with the on time value and if they match, the controller 302 activates the switches 306 and energizes the water heater 318 and hot plate 320. After a predetermined time period (usually two hours), the coffee maker appliance 100 is turned “off” automatically. The coffee maker appliance will not turn on again until the on/off/auto switch 108 is moved to the “off” position and back to the “auto” position. In an alternate embodiment, the coffee maker appliance will turn “on” every time the on time value matches the real time clock 308.

The controller 302 activates a safety timer whenever the coffee maker appliance 100 is activated. The safety timer is fixed at one hour and upon expiration of the safety timer the controller 302 generates a safety timer signal that deactivates the switches 306 and removes power from the water heater 318 and the hot plate 320. The controller activates the safety time by identifying a time one hour from the current time taking into account leap years and changes from or to DST. Thus, thus the safety timer is not a count, but a comparison of current time to another time value.

The coffee maker appliance 100 has an antenna 326 connected to receiver 324 for reception of a WWVB time signal that is transmitted at 60 kHz. A decoder 314 is connected to the receiver 324 and decodes the WWVB time signal. The decoder first looks to synchronize to the WWVB time signal. The WWVB time signal packet is encoded in such a way that the decoder only has to identify two adjacent 0.8 second pulse to identify the start of a new packet that represents a minute in real time. Thus, synchronization to the signal can be achieved prior to decoding the entire packet. Another advantage of synchronization to the two adjacent 0.8 second pulses is the ability to design the receiving circuit without having to use automatic gain control. In an alternate embodiment, the receiver 324 is activated or turned on at predetermined intervals, rather than continuous operation, resulting in power savings when both the primary and secondary power supplies have limited supply life (such as batteries).

To assure accurate reception of the time signal, a double frame detection technique is used. The double frame detection technique of identifying the top of minute is a free-running integrator in the decoder that triggers at a specific energy level that is equivalent to two frame bits in succession. The technique of measuring this energy level is realized by the fact that double frames are never transmitted by WWVB except for the top of each minute. In an alternate embodiment, single frame detection may selectively be use to identify the end and beginning of a packet.

Once a couple of packets have been received and synchronization is attained, the frames in the packet are decoded to identify the current UTC time. Upon successfully decoding two consecutive time signal packets, the decoder 314 communicates the decoded time to the controller 302 that updates the real time clock 308. The controller 308 also activates the indicator light 104 (a human perceptible indicator) to show that the clock has been synchronized with the time signal. If the time signal is lost, then the indicator light 104 stays lit for a predetermined period (10 days) in the present embodiment. If during the previous 10 days no time signal is received and/or properly decoded, then the controller 302 deactivates the indicator light 104.

Upon synchronization with the WWVB time signal, packets that contain errors can be corrected. Since a number of packets have been properly decoded, the time is known and the passing of each minute is detected without decoding the frame. During the processing of a Packet of Data, synchronization by the Double Frame Detection has already occurred. Since we are in sync, we can correct for improperly received Single Frames (within the current packet) that reside in the correct timing position. The method for recovery, as long as the single frame error bits reside in the proper timing position, is to convert any single frame error bits that are received to the opposite value. Therefore, if the previous minute is known and the change to the next minute is detected, then the decoder 314 can correct errors in the packet using predictive framing when a frame (or multiple frames) in a packet is corrupted.

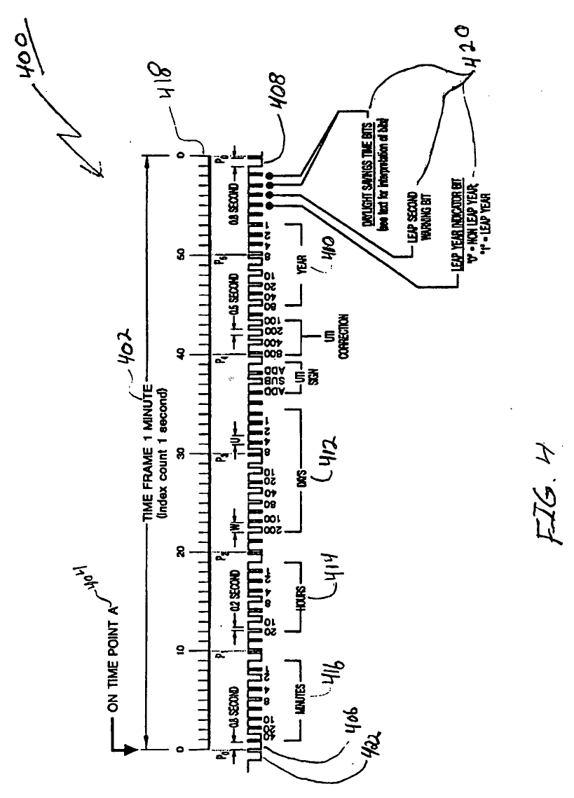

In FIG. 4, an illustration of a time signal packet received by the receiver of FIG. 3 is shown. The time signal packet is a WWVB time signal and requires one minute to be transmitted. WWVB continuously broadcasts time and frequency signals at 60 kHz. The carrier frequency provides a stable frequency reference traceable to the national standard. There are no voice announcements on the station, but a time code is synchronized with the 60 KHz carrier and is broadcast continuously at a rate of 1 bit per second using pulse width modulation. The carrier power is reduced and restored to produce the time code bits used within a frame 400. The carrier power is reduced 10 dB at the start of each second, so that the leading edge of every negative going pulse is on time. Full power is restored 0.2 seconds later for a binary “0”, 0.5 seconds later for a binary “1”, or 0.8 seconds later to convey a position marker 406 and 408. The binary coded decimal (BCD) format is used so that binary digits in the frame 400 are combined to represent decimal numbers. The time code contains the year 410, day of year 412, hour 414, minute 416, second 418, and flags 420 that indicate the status of Daylight Saving Time, leap years, and leap seconds. The frequency uncertainty of the WWVB signal as transmitted is less than 1 part in 10¹². If the path delay is removed, WWVB can provide UTC with an uncertainty of less than 100 microseconds.

The flags 420 are for information pertaining to leap years, DST, and leap seconds. The leap year bit is transmitted at second or frame 55 in the packet 400. If it is set to “1”, then the current year is a leap year. The bit is set to “1” during each leap year sometime after January 1, but before February 29. It is set back to “0” shortly after January 1 of the year following the leap year.

The two DST flag bits are set at seconds or frame 57 and 58 in the packet. If “Standard” time is in effect, both bits are set to “0”. If “Daylight Standard Time” (DST) is in effect, both bits are set to 1. On the day of change from “Standard” to DST, second 57 bit is changed from “0” to “1” at 0000 UTC. Exactly twenty-four hours later, second bit 58 also changes from “0” to “1” at 0000 UTC. On the day of change from DST back to “Standard” time second 57 bit goes from “1” to “0” at 0000 UTC, followed twenty-four hours later by second bit 58 going from “1” to “0”. Thus, upon decoding a frame that indicates daylight savings time bits being set or reset results in the controller 302 transitioning the real time clock 308 between DST and “Standard” time. In an alternate embodiment, other types of radio frequency (RF) timing signals may be used, such as DCF-77 time signal.

The decoder 314 of FIG. 3 searches the received signal in order to identify the 10 dB power reduction to signify the start of a second followed 0.8 seconds later by full power. The first occurrence identified will be the end 422, FIG. 4 of the previous packet and the next 10 dB power reduction followed 0.8 seconds later by full power identifies the start of the current packet 406. Thus, when two consecutive 10 dB power reductions, each followed by a 0.8 seconds later by full power, are detected, then the identification of a new minute is achieved and the packet can be decoded.

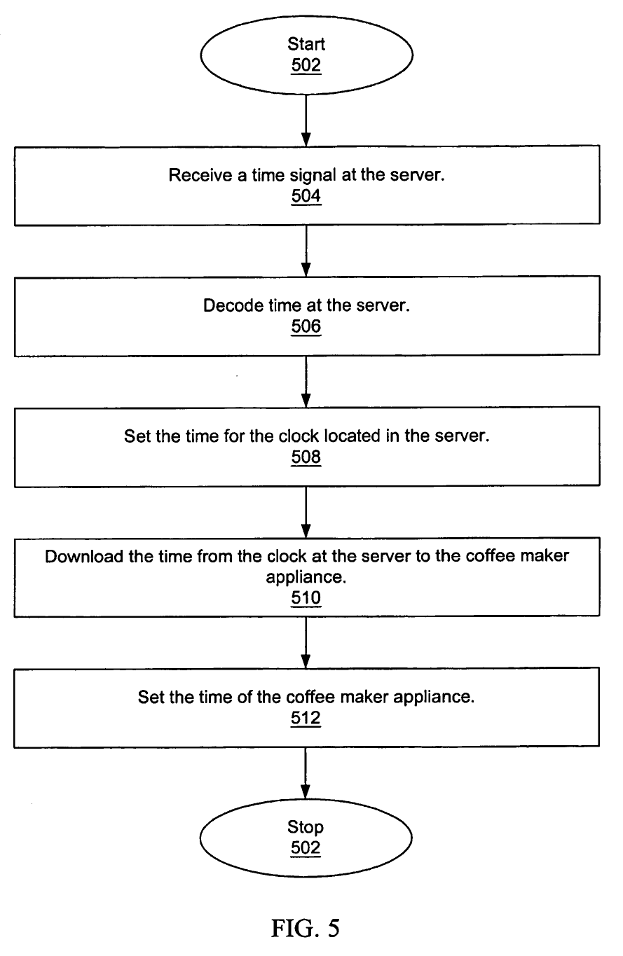

In FIG. 5 a flow chart illustration of a process of initially setting the time in the coffee maker appliance as depicted in FIG. 2 is shown. The process starts at step 502 and a time signal is received at the server 202 in step 505. The received time signal is decoded and the year, day, minute, and second (time value) are identified in step 506. In step 508, the clock located in server 202 is set with the decoded year, day, minute, and second (time value) that were identified in step 506.

The coffee maker appliance 100 is connected to the server 202 and the time value from the clock in the server 202 is downloaded into the coffee maker appliance 100. The controller 302 receives the time value from the server 202 via an I/O port connected to the controller 302 in step 510. The controller 302 sets the real time clock 308 to the received time value from the server 202 in step 512. Once the coffee maker appliance 100 has the correct time it is disconnected from communication with the server 202 and is free running until it receives and decodes a time signal.

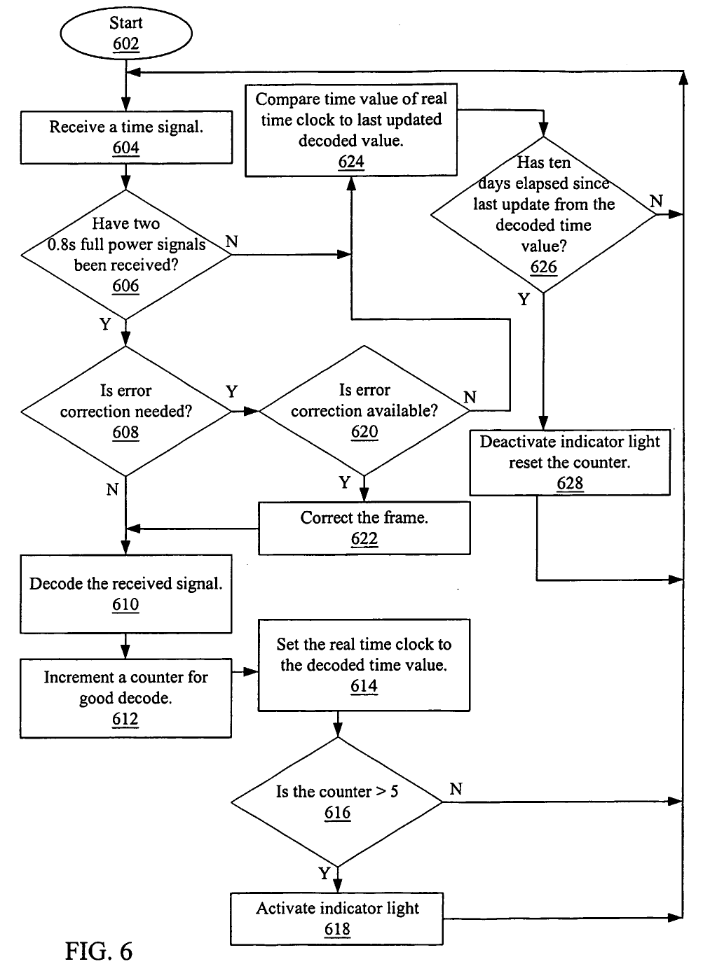

Turning to FIG. 6, a flow chart illustration of a process of setting time from the received time signal in a coffee maker appliance of FIG. 3 is shown. The process starts in step 602 and a time signal is received via the antenna 320 at the receiver 324 in step 604. In step 606, the decoder 314 attempts to identify two 0.8 second full power signals within the received time signal that signify a new minute has begun. If two 0.8 second full power signals are detected than the decoder 314 determines if error correction is required in step 608. If in step 608, the decoder 314 determines that error correction is not required, the time signal is decoded into a time value in step 610. A counter is incremented by the controller 302 in step 612 to signify that a time value has been decoded. In step 614, the controller 302 sets the real time clock to the decoded time value.

The counter is checked in step 616 to determine if a predetermined number of time values have been decoded (greater than 5 in the present example). If the counter indicates that more than five time values have been properly decoded in step 616, then in step 618, a indicator light is activated. The process is continuous while the coffee maker appliance 100 is plugged in an electrical outlet. When unplugged from an electrical outlet, the second power supply keeps the real time clock operating, but no signals are received or decoded in the present embodiment. Since the process is continuous while plugged into an outlet, the receiver is continuously receiving the time signal.

If the two 0.8 second full power signals identifying the start of a minute frame are not detected in step 606, then in step 624 the a comparison between the real time clock and the last time value update occurs. If more than ten days have elapsed since the last update from the decoded time value in step 626, then the indicator light is deactivated and the counter rest in step 628 and processing of the time signal continues. Otherwise, ten days have not elapsed and processing of the time signal continues.

If error correction is required in step 608, then a determination is made if error correction is possible in step 620. At least two frames must be decoded before error correction of corrupted frames can occur with sufficient accuracy. If error correction is available, then in step 622, the frame is corrected. Otherwise, error correction is unavailable and step 624 is executed.

It is appreciated by those skilled in the art that the process shown in FIG. 5 and FIG. 6 may be selectively be implemented in hardware, software, or a combination of hardware and software. An embodiment of the process steps employs at least one machine-readable signal bearing medium. Examples of machine-readable signal bearing mediums include computer-readable mediums such as a magnetic storage medium (i.e. floppy disks, or optical storage such as compact disk (CD) or digital video disk (DVD)), a biological storage medium, or an atomic storage medium, a discrete logic circuit(s) having logic gates for implementing logic functions upon data signals, an application specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium could even be paper or another suitable medium, upon which the computer instruction is printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing mediums. Computer-readable signal bearing mediums have a modulated carrier signal transmitted over one or more wire based, wireless or fiber optic networks or within a system. For example, one or more wire based, wireless or fiber optic network, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions.

A coffee maker appliance 100 has been used to describe the invention. The invention can be used in any home or kitchen appliance, including washers, dryers, dishwashers, microwave ovens, mixers, stoves, grills, and rotisseries to name a few. The invention can also be used with various types of clocks, including wall clocks, table clocks and alarm clocks to name a few. While various embodiments of the invention have been described, it will be apparent to those of ordinary skill in the art that many more embodiments and implementations are possible that are within the scope of this invention.

1. A method of reporting time in an appliance comprising the steps of:
receiving a radio signal having an encoded time signal at a receiver located in the appliance;
decoding the encoded time signal into at least one time value;
setting a clock with the at least one time value, wherein the clock is in communication with the receiver; and
activating an indicator when the clock is set with the at least one time value.

2. The method of claim 1, where the step of receiving further comprises the step of activating the receiver at predetermined intervals.

3. The method of claim 1, where the step of decoding further comprises the steps of identifying the beginning of a WWVB time packet in the encoded time signal, and extracting at least one time value from the WWVB time packet.

4. The method of claim 1, where the step of decoding further comprises the steps of identifying the beginning of a DCF-77 time packet in the encoded time signal and, extracting at least one time value from the DCF-77 time packet.

5. The method of claim 1, where the step of decoding further comprises the step of identifying a minute change.

6. The method of claim 5, where the step of identifying further includes the step of identifying a peak of a double frame in a WWVB signal.

7. The method of claim 1, where the step of decoding further comprises the steps of identifying a leap year indicator in the at least one time value, and adjusting the clock with the at least one time value in response to the leap year indicator.

8. The method of claim 1, where the step of setting further includes the step of updating the clock at a predetermined interval.

9. The method of claim 8, wherein the predetermined interval is one minute.

10. The method of claim 1, where the step of activating further comprises the step of activating a human perceptible indicator.

11. The method of claim 10, where the step of activating further comprises the step of activating a visual indicator.

12. The method of claim 11, wherein the visual indicator is a light indicator.

13. The method of claim 11, wherein the visual indicator is a mechanical indicator.

14. The method of claim 1, wherein the step of activating further comprises the step of activating an audio indicator.

15. The method of claim 1, including the step of deactivating the indicator when the setting step does not occur within a predetermined period of time, wherein the predetermined period of time is starts when the indicator is activated.

16. The method of claim 1, including the step of activating a safety timer when the appliance is activated.

17. The method of claim 16, where the step of activating a safety timer further comprises the step of identifying a predetermined future time, and
adjusting the predetermined future time for a time change.

18. A method of reporting time in an appliance comprising the steps of:
receiving a radio signal having an encoded time signal at a receiver located in the appliance;
detecting a synchronization pattern in the radio signal;
decoding the encoded time signal into at least one time value; and
setting a clock with the at least one time value, wherein the clock is in communication with the receiver.

19. The method of claim 18, where the step of receiving further comprises the step of activating the receiver at predetermined intervals.

20. The method of claim 18, where the step of decoding further comprises the steps of identifying the beginning of a WWVB time packet in the encoded time signal, and extracting at least one time value from the WWVB time packet.

21. The method of claim 18, where the step of decoding further comprises the steps of identifying the beginning of a DCF-77 time packet in the encoded time signal and, extracting at least one time value from the DCF-77 time packet.

22. The method of claim 18, where the step of detecting further comprises the step of identifying a minute change.

23. The method of claim 22, where the step of identifying further includes the step of identifying a peak of a double frame.

24. The method of claim 18, where the step of decoding further comprises the steps of identifying a leap year indicator in the at least one time value, and adjusting the clock with the at least one time value in response to the leap year indicator.

25. The method of claim 18, where the step of setting further includes the step of updating the clock at a predetermined interval.

26. The method of claim 25, wherein the predetermined interval is one minute.

27. The method of claim 18, further including, the step of activating an indicator when the clock is set with the at least one time value.

28. The method of claim 27, where the step of activating further comprises the step of activating a human perceptible indicator.

29. The method of claim 28, wherein the human perceptible indicator is a light indicator.

30. The method of claim 28, wherein the human perceptible indicator is a mechanical indicator.

31. The method of claim 27, wherein the indicator is an audio indicator.

32. The method of claim 27, including the step of deactivating the indicator when the setting step does not occur within a predetermined period of time, wherein the predetermined period of time is starts when the indicator is activated.

33. The method of claim 18, including the step of activating a safety timer when the appliance is activated.

34. The method of claim 33, where the step of activating a safety timer further comprises the step of identifying a predetermined future time, and
adjusting the predetermined future time for a time change.

35. A method of reporting time in an appliance comprising the steps of:
receiving a time value from an external device directly coupled to the appliance;
setting a clock to with the time value;
uncoupling from the external device; and
powering the clock from a secondary power source.

36. The method of claim 36, wherein the time value is associated with a GPS signal.

37. The method of claim 36, wherein the time value is associated with a WWVB time signal.

38. The method of claim 36, wherein the time value is associated with a network time signal.

39. An apparatus that reports time, comprising:
a receiver able to receive a radio signal having an encoded time signal;
a decoder coupled by a signal path to the receiver that decodes the encoded time signal into at least one time value;
a clock;
a controller coupled by at least one other signal path to the clock and the decoder, wherein the controller updates the clock with the at least one time value from the decoder.

40. The apparatus of claim 40, wherein the receiver is activates at predetermined time to receive the encoded time signal.

41. The apparatus of claim 40, wherein the decoder identifies a WWVB time packet in the encoded time signal and a plurality of frames located within the WWVB time packet.

42. The apparatus of claim 40, wherein the decoder identifies a DCF-77 time packet in the encoded time signal and a plurality of frames located within the DCF-77 time packet.

43. The apparatus of claim 40, wherein the decoder identifies a minute change.

44. The apparatus of claim 44, wherein the decoder locating a peak of a double frame in a WWB signal identifies the minute change.

45. The apparatus of claim 40, wherein a plurality of flags represent a time change are detected in the encoded time signal when decoded by the decoder and the controller processing the flag from the decoder resulting in the clock being updated in accordance with the flag.

46. The apparatus of claim 40, further comprising an indicator electrically coupled to the controller that is activated upon the clock being updated with the at least one time value.

47. The apparatus of claim 47, wherein the indicator is a mechanical indicator.

48. The apparatus of claim 47, wherein the indicator is audio indicator.

49. The apparatus of claim 47, wherein the indicator is a visual indicator.

50. The apparatus of claim 47, wherein the visual indicator is deactivated when at least one time value is not received within a predetermined period of time.

51. The apparatus of claim 40, wherein the controller sets a safety timer by determining a predetermined future time and generates a safety timer signal upon the clock matching the predetermined future time.

52. The apparatus of claim 52, wherein controller adjusts the predetermined future time in response to the decoder detecting at least one flag from the plurality of flags that represents the time change.

53. A time setting system, comprising:
a server having a receiver for reception of a time signal that results in a time value;
an appliance with a input/output port coupled to a controller and a clock, in physical contact with the server, wherein the controller updates the clock with the time value upon receipt at the appliance of the time value.

54. The system of claim 36, wherein the time value is associated with a GPS signal.

55. The system of claim 36, wherein the time value is associated with a WWVB time signal.

56. The system of claim 36, wherein the time value is associated with a network time signal.

57. The system of claim 54, wherein the clock is powered by a secondary power supply located in the appliance after receipt of the time value.

58. A signal bearing media having machine readable instructions for adjusting image lighting on a preparatory image, comprising:
a first set of machine readable instructions for receiving a radio signal having an encoded time signal at a receiver;
a second set of machine readable instructions for decoding the encoded time signal into at least one time value;
a third set of machine readable instructions for setting a clock with the at least one time value; and
a fourth set of machine readable instructions for activating an indicator when the clock is set with the at least one time value.

59. The signal bearing media of claim 59, wherein the second set of instructions further comprise, instructions for identifying the beginning of a WWVB time packet in the encoded time signal, and
another set of instructions for extracting at least one time value from the WWVB time packet.

60. The signal bearing media of claim 60, wherein the instructions for identifying the beginning of a WWVB time packet, further include instructions for identifying a peak of a double frame in the encoded time signal.

61. A signal bearing media having machine readable instructions for adjusting image lighting on a preparatory image, comprising:
a first set of machine readable instructions for receiving a radio signal having an encoded time signal at a receiver;
a second set of machine readable instructions for decoding the encoded time signal into at least one time value; and
a third set of machine readable instructions for setting a clock with the at least one time value.

62. The signal bearing media of claim 59, wherein the second set of instructions further comprise, instructions for identifying the beginning of a WWVB time packet in the encoded time signal, and
another set of instructions for extracting at least one time value from the WWVB time packet.

63. The signal bearing media of claim 60, wherein the instructions for identifying the beginning of a WWVB time packet, further include instructions for identifying a peak of a double frame in the encoded time signal.
